(19) United States
(12) Patent Application Publication
(10) Pub. No.: US 2023/0181955 A1
(43) Pub. Date: Jun. 15, 2023

(54) Portable Fire Extinguisher and a Method for Arranging an Automatic Fire Extinguishing System to a Space

(71) Applicant: Jarno HAPPONEN, Vantaa (FI)

(72) Inventor: Jarno HAPPONEN, Vantaa (FI)

(21) Appl. No.: 17/923,655

(22) PCT Filed: May 5, 2021
(86) PCT No.: PCT/FI2021/050333

§ 371 Date: Nov. 7, 2022

(30) Foreign Application Priority Data
May 7, 2020 (FI) 20205464

(51) Int. Cl. A62C 37/40; A62C 3/00; A62C 13/78

(52) U.S. Cl. CPC A62C 37/40; A62C 3/002; A62C 13/78

(57) ABSTRACT

The portable fire extinguisher comprises a housing (10) with a wall, an extinguishant unit (12) containing an extinguishing agent within the housing, a temperature-responsive extinguishant unit activator (14), and at least one extinguishing agent discharge pipe (16) leading from the inside of the housing to the outside of the housing. An activator is inside the housing and the housing has a flow channel for conducting external air to the activator. In the event of a fire, the temperature of the air outside the housing rises and the heated air is connected via the flow channel to the activator, which triggers the fire extinguisher.

### FIELD OF THE INVENTION

The invention relates to a portable fire extinguisher comprising a housing with a wall, an extinguishant unit containing an extinguishing agent within the housing, a temperature-responsive extinguishant unit activator, and at least one extinguishing agent discharge pipe leading from the inside of the housing to the outside of the housing. The invention further relates to a method for arranging an automatic fire extinguishing system to a space.

### PRIOR ART

Shipping containers are widely used for freight transport. The containers are locked during transport, leaving the cargo in an enclosed space for several days and even weeks. Cargo carried in sea containers may contain substances or equipment which may catch fire during the handling or transport of the container. Cargo containing various chemicals or electrical appliances with a power supply in place are particularly flammable. Extinguishing a fire in a sea container is particularly difficult because the burning container may be located on the deck of a ship far away at sea, tightly surrounded by other containers.

Cargo ships have their own fire extinguishing systems, which usually use water as an extinguishing agent. With these extinguishing systems it is often difficult to reach individual containers in container stacks. In addition, the use of water as an extinguishing agent is insufficient if the burning cargo contains oil, chemicals or batteries.

CN 210205660 U, US 2017/0120089 Al and CN 209529941 U describe fire extinguishers permanently mounted in transport containers. Such equipment is expensive and cumbersome to install and also reduces the space available for container cargo. In addition, fixed fire extinguishers cannot be easily removed from the container, meaning they unnecessarily take up space in the container when the cargo carried in the container is not flammable.

US 2008/0314602 A1 describes a portable fire extinguishing apparatus with a housing that has a tank in it, which contains a fire extinguishing agent. The outer surface of the housing has nozzles protruding from the surface of the housing.

Outside the housing is a heat-sensitive valve which, when it heats up, opens a flow path for the extinguishing agent from the tank to the nozzles. The outer surface of the device has permanently mounted magnets that allow the fire extinguisher to attach to a ferromagnetic material. The fire extinguisher disclosed is intended to be installed in a kitchen, above a stove or oven. The heat-sensitive valve located outside the housing and the nozzles protruding from the surface of the housing are susceptible to breakage, which makes the apparatus ill-suited for use in confined spaces.

CN 204655839 describes an automatic fire extinguishing apparatus comprising extinguishing aerosol contained in a closed housing. One wall of the housing has a self-adhesive surface that allows the housing to be attached to a desired object. In the event of a fire, the heat will melt a hole in the wall of the housing, releasing the extinguishing aerosol into the surrounding space. The extinguishing aerosol release mechanism based on the bursting of the housing is functionally uncertain.

The object of the invention is to provide a fire extinguisher and a method which can reduce the problems associated with the prior art. The objects of the invention are achieved by a fire extinguisher and a method which are characterized by what is set out in the independent claims. Some preferred embodiments of the invention are set out in the dependent claims.

### BRIEF SUMMARY OF THE INVENTION

The invention relates to a portable fire extinguisher comprising a housing with a wall, an extinguishant unit containing an extinguishing agent within the housing, a temperature-responsive extinguishant unit activator, and at least one extinguishing agent discharge pipe leading from the inside of the housing to the outside of the housing. Said activator is inside the housing and the housing has a flow channel for conducting external air to the activator. In the event of a fire, the temperature of the air outside the housing rises and the heated air is connected via the flow channel to the activator, which triggers the fire extinguisher.

In a preferred embodiment of the fire extinguisher according to the invention, there is, inside the housing, a heat detector chamber in which at least a part of the activator is located and into which the flow channel opens. Preferably, the heat detector chamber is connected to the discharge pipe. In this case, the discharge pipe acts as a flow channel for the external air supplied to the activator.

In another preferred embodiment of the fire extinguisher according to the invention, said activator is an electric pulse trigger operating without external energy. The electric pulse trigger stores mechanical energy that is released when the activator is triggered and produces an electric pulse which triggers the extinguishant unit.

In another preferred embodiment of the fire extinguisher according to the invention, there is, inside the housing, a protective chamber, in which the extinguishant unit is placed, and the discharge pipes have a first end opening into the protective chamber and a second end opening into the outer surface of the housing. The protective chamber stops the spreading of the extinguishing agent from the triggered extinguishant unit to the entire interior of the housing; instead, it only fills the protective chamber from where it discharges in a controlled manner along the discharge pipes to the outside of the housing. The extinguishing agent cannot thus interfere with the operation of any other devices inside the housing.

In another preferred embodiment of the fire extinguisher according to the invention, the extinguishant unit contains an extinguishing chemical in a solid state. The solid-state extinguishing chemical becomes a gaseous aerosol when the extinguishant unit is activated by the activator.

In another preferred embodiment of the fire extinguisher according to the invention, the extinguishant unit contains a fire extinguishing or cooling gas, liquid or powder. The gas may contain argon, nitrogen and/or carbon dioxide.

Another preferred embodiment of the fire extinguisher according to the invention has detection means for indicating the triggering of the extinguishant unit. Preferably, the detection means comprises a heat-activated label on the wall of the housing. Alternatively or in addition, said detection means may comprise wireless communication means inside the housing.

Another preferred embodiment of the fire extinguisher according to the invention has at least one mounting magnet inside the housing for attachment to a ferromagnetic body. Preferably, the device comprises a handle, the handle having a first portion extending inside the housing in communication with the mounting magnet and a second portion extending outside the housing so that the position of the mounting magnet relative to the wall of the housing can be changed by turning the second portion of the handle.

Another preferred embodiment of the fire extinguisher according to the invention is arranged to operate without an external energy source. In this embodiment, the parts included in the device may operate mechanically, or the device may have its own power supply so that the electric power stored in the power supply enables the device to operate autonomously for the planned operating time.

Another preferred embodiment of the fire extinguisher according to the invention has a hub connection for connecting to an external device, such as an external triggering device. The hub connection comprises at least one known communication port, for example a USB port, an Ethernet interface or a PCMCIA interface.

Another preferred embodiment of the fire extinguisher according to the invention can be connected in series with at least one other fire extinguisher. The series connection can be implemented using the hub connection. All the fire extinguishers connected in series can be arranged to trip simultaneously or in succession when one of the fire extinguishers connected in series trips.

The method of the invention for arranging an automatic fire extinguishing system in a space comprises an extinguishant unit containing an extinguishing agent, a temperature-responsive extinguishant unit activator, and at least one extinguishing agent discharge pipe for controlling the discharge of the extinguishing agent. In the method, at least one fire extinguisher as described above is installed inside the space.

In a preferred embodiment of the method according to the invention, said fire extinguisher is installed in a movable transport space, such as a shipping container, a train carriage or a truck trailer. Preferably, said fire extinguisher is installed in the movable transport space for the duration of the transport of the cargo and said fire extinguisher is removed from the sea container after the transport of the cargo.

In another preferred embodiment of the method according to the invention, said fire extinguisher is installed in a movable passenger space or vehicle, such as a construction site module or a caravan.

An advantage of the invention is that it is reliable and mechanically durable, since it operates without external energy and all the parts belonging to the device are placed inside a housing which protects them against mechanical stress.

Another advantage of the invention is that it can be easily scaled to different sized spaces either by increasing the size of an individual fire extinguisher and/or by connecting individual fire extinguishers in series.

### BRIEF DESCRIPTION OF THE DRAWINGS

The invention is described in detail below. In the description, reference is made to the accompanying drawings in which

FIG. 1 shows, by way of example, a top view of a fire extinguisher according to the invention,

FIG. 2 shows, by way of example, a fire extinguisher according to the invention mounted on a surface.

### DETAILED DESCRIPTION OF THE INVENTION

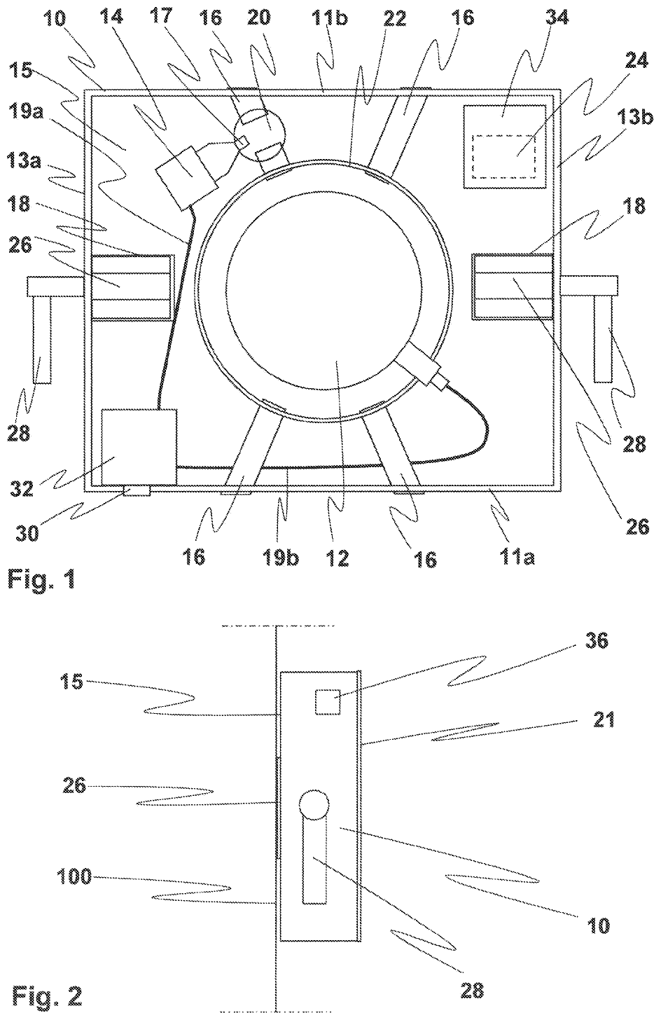

FIG. 1 shows, by way of example, a fire extinguisher according to the invention as seen from above. The fire extinguisher has a rectangular housing 10 with an openable lid. In FIG. 1, the lid of the housing has been removed to better show the structure of the device. The housing has a base 15, first and second side walls 11a, 11b and first and second end walls 13a, 13b. The housing is made of a material resistant to moisture, impacts, fire and corrosion, such as a suitable plastic material or composite material. Preferably, the housing is made of a metal such as aluminum.

Inside the housing there is a protective chamber with a cylindrical wall. The wall of the protective chamber joins the base at its first edge and its second edge abuts the lid (not shown). Inside the protective chamber there is an extinguishant unit 12 which contains an extinguishing aerosol and has a coupling branch extending through the wall of the protective chamber. The extinguishant unit comprises a metal tank containing a specialty chemical in a solid state. Preferably, the specialty chemical contains potassium nitrate. An activator generating an electric pulse that triggers the extinguishant unit is connected to the coupling branch. When the activator triggers the extinguishant unit, the solid-state specialty chemical undergoes a chemical reaction and turns into an extinguishing aerosol, which is discharged from the tank into the protective chamber, from where it is distributed via the discharge pipes out of the housing. Preferably, the extinguishing aerosol contains powdered potassium carbonate, nitrogen gas, carbon dioxide and water vapor.

The wall of the protective chamber has four holes, to each of which a discharge pipe 16 is connected so that a first end of the discharge pipe opens into the protective chamber and a second end of the discharge pipe opens outside the housing. In the fire extinguisher shown in FIG. 1, the second ends of the discharge pipes open into the side walls 11a, 11b of the housing so that the second ends are substantially flush with the outer surface of the side walls. A section between the first and second ends of one discharge pipe has been cut off. At the cut-off point, there is a heat detector chamber 20 so that the severed ends of the discharge pipe open into the heat detector chamber. The heat detector chamber has a cylindrical wall which joins the base at its first edge, the second edge abutting the lid when installed. Since the heat detector chamber is connected to the outside of the housing through the severed discharge pipe, the temperature in the heat detector chamber and outside the housing is substantially the same.

Inside the housing 10, there is an extinguishant unit activator 14 attached to the base 15. The activator is an electromechanical electric pulse trigger known as such. The electric pulse trigger stores mechanical energy that is released when the activator is triggered and produces an electric pulse which triggers the extinguishant unit. The electric pulse trigger is triggered when the heat-sensitive element 17 at its tip heats up above the trigger temperature of the trigger. The trigger temperature of the activator can be 70-110° C. The electric pulse trigger is placed in the housing so that the heat-sensitive element at its tip extends through a hole in the wall of the heat detector chamber to the inside of the heat detector chamber. Preferably, the electric pulse trigger can be a TAG pulse device marketed by Salgrom Technologies Oy.

The electric pulse device is connected by a first cable 19a to a coupling box 32, which in turn is connected by a second cable 19b to the coupling branch of the extinguishant unit 12. In connection with the coupling box, there is a hub connector 30, by means of which the fire extinguisher can be connected to an external device, such as an external triggering device. By means of the hub connector, several fire extinguishers can be connected in series so that all the fire extinguishers connected in series are triggered substantially simultaneously or in succession when the electric pulse trigger of one fire extinguisher is activated.

In addition, there are two mounting magnets 26 inside the housing, by means of which the fire extinguisher is intended to be mounted on a ferromagnetic surface. The mounting magnets are polygonal pieces with a plurality of flat surfaces. The mounting magnets are attached to the end walls of the housing by a handle 28 having a first portion extending inside the housing and securing to the mounting magnet and a second portion extending outside the housing. The base has holes 18 at the mounting magnets. The mounting magnets are pivotable to a first position in which the gripping surface of the mounting magnet is positioned parallel to the base at the hole in the base so that the mounting magnet extends through the hole 18 slightly outside the housing. In this position, the gripping surface of the mounting magnet can adhere to a surface of a body made of a ferromagnetic material outside the housing, such as the wall of a shipping container. Correspondingly, by turning the handle, the mounting magnets can be turned to a second position in which the gripping surface of the mounting magnet is turned at an angle from the plane of the base, whereby the mounting magnet detaches from the ferromagnetic surface.

Inside the housing there is also a box containing wireless communication means 24. The communication means comprise an antenna and a transceiver which can operate in a wireless communication network, such as a 4G or 5G mobile network, a WLAN, an NB-lot, a Zigbee, a LoRa or a Bluetooth network. Inside the box is a battery for storing the electrical power needed by the communication means.

FIG. 2 shows, by way of example, a side view of the fire extinguisher shown in FIG. 1 attached to a ferromagnetic surface 100. The fire extinguisher according to the invention is a continuously ready-to-operate device, all functional parts of which are placed inside a housing 10 provided with an openable lid 21. Except for the handles 28, the housing has no protruding parts. The fire extinguisher is attached by mounting magnets to a ferromagnetic surface, such as a steel plate, by placing the housing base 15 against the ferromagnetic surface and turning the handles so that the mounting magnets 26 adopt a position where the gripping surfaces of the mounting magnets protrude slightly from the bottom holes against the ferromagnetic surface 100. After installation, the fire extinguisher is immediately operational. If the need for extinguishing ceases or changes, the fire extinguisher can be easily removed by turning the handles 28 so that the mounting magnets detach from the ferromagnetic surface. If there is no ferromagnetic surface in the space where the fire extinguisher is to be installed, the fire extinguisher can be secured in place with lashing straps, ropes, belts, wall hooks or screws. The fire extinguisher does not necessarily have to be attached at all, but can simply be placed on a platform or floor, for example.

The outer surface of the housing wall has a heat-activated label 36 that changes color or appearance when the temperature of the label exceeds the trigger temperature of the fire extinguisher. The heat-activated label thus acts as an indicator means which shows the user of the device whether the fire extinguisher is in working order or whether the fire extinguisher contained therein has triggered. A fire extinguisher that has triggered can be made operational again by replacing its activator and extinguishant unit.

By means of the fire extinguisher according to the invention, an automatic fire extinguishing system can be formed in any space simply by placing one or more fire extinguishers in that space. The fire extinguishers placed in the space can operate independently or they can be connected in series via a hub connection. An alternative to series connection via a hub connection is to place the fire extinguishers in the space so that a jet of hot gas discharged from one triggered fire extinguisher is directed to a discharge pipe leading to the heat detector chamber of an adjacent second fire extinguisher. In this way, the triggering of the first fire extinguisher causes the adjacent fire extinguisher to trigger quicker than would occur due to an increase in the ambient temperature in the space. The triggering of the fire extinguisher carried out in the above-mentioned manner is called hot gas ignition.

The fire extinguisher is particularly well suited to provide an automatic fire extinguishing system in an enclosed space, such as a shipping container, a train carriage, a truck trailer or a construction site module. At least one fire extinguisher is attached inside the shipping container, trailer or construction site module so that in the event of a fire, the extinguishing agent from the fire extinguisher can spread in the entire interior of the space. The fire extinguisher can be mounted on the walls, ceiling, door or floor of the space.

The fire extinguisher can be attached to the container for the duration of the transport of flammable cargo in a sea container or trailer and removed from the container or trailer after the transport of the cargo. The fire extinguisher is particularly well suited for providing an automatic fire extinguishing system for shipping containers, carriages and trailers carrying cargo containing charged batteries, such as electric cars.

Some preferred embodiments of the portable fire extinguisher and the method according to the invention have been described above. The invention is not limited to the solutions described above, but the inventive idea can be applied in various ways within the scope set by the claims.

### LIST OF REFERENCE NUMBERS

10 housing

11a first side wall

11b second side wall

12 extinguishant unit

13a first end wall

13b second end wall

14 activator

15 base

16 discharge pipe

17 heat-sensitive element

18 hole

19a first cable

19b second cable

20 heat detector chamber

21 lid

22 protective chamber

24 communication means

26 mounting magnet

28 handle

30 hub connection

32 coupling box

34 box

36 heat-activated label

100 ferromagnetic surface

1. A portable fire extinguisher comprising a housing (10) with a wall, an extinguishant unit (12) containing an extinguishing agent within the housing (10), a temperature-responsive extinguishant unit (12) activator (14),), which activator (14) is inside the housing and which housing (10) has a flow channel for conducting external air to the activator (14) and at least one extinguishing agent discharge pipe (16) leading from the inside of the housing (10) to the outside of the housing (10), characterized in that it comprises at least one mounting magnet (26) inside the housing (10) for attachment to a ferromagnetic body and a handle (28), the handle (28) having a first portion extending inside the housing (10) in communication with the mounting magnet (26) and a second portion extending outside the housing (10) so that the position of the mounting magnet (26) relative to the wall of the housing (10) can be changed by turning the second portion of the handle (28).

2. The fire extinguisher of claim 1, characterized in that, inside the housing (10), there is a heat detector chamber (20) in which at least a part of the activator (14) is located and into which the flow channel (20) opens.

3. The fire extinguisher of claim 2, characterized in that the heat detector chamber (20) is connected to a discharge pipe (16).

4. The fire extinguisher of claim 1, characterized in that said activator (14) is an electric pulse trigger operating without external energy.

5. The fire extinguisher of claim 1, characterized in that, inside the housing (10), there is a protective chamber (22), in which the extinguishant unit (12) is placed, and the discharge pipes (16) have a first end opening into the protective chamber (22) and a second end opening into the outer surface of the housing (10).

6. The fire extinguisher of claim 1, characterized in that the extinguishant unit (12) contains a fire extinguishing chemical in a solid state.

7. The fire extinguisher of claim 1, characterized in that the extinguishant unit (12) contains a fire extinguishing or cooling gas, liquid or powder.

8. The fire extinguisher of claim 1, characterized in that the device has indication means for indicating the triggering of the extinguishant unit (12).

9. The fire extinguisher of claim 8, characterized in that said indication means comprises a heat-activated label on the wall of the housing (10).

10. The fire extinguisher of claim 8, characterized in that said indication means comprises a wireless communication means (24) inside the housing (10).

11. (canceled)

12. (canceled)

13. The fire extinguisher of claim 1, characterized in that it is arranged to operate without an external energy source.

14. The fire extinguisher of claim 1, characterized in it has a hub connection (30) for connecting to an external device, such as an external triggering device.

15. The fire extinguisher of claim 1, characterized in that it can be connected in series with at least one other fire extinguisher.

16. A method for arranging an automatic fire extinguishing system in a space, which fire extinguishing system comprises an extinguishant unit (12) containing an extinguishing agent, a temperature-responsive extinguishant unit activator (14), and at least one extinguishing agent discharge pipe (16) for controlling the discharge of the extinguishing agent, characterized in that at least one fire extinguisher according to claim 1 is installed inside the space.

17. The method of claim 16, characterized in that said fire extinguisher is installed in a movable transport space, such as a shipping container, a train carriage or a truck trailer.

18. The method of claim 17, characterized in that said fire extinguisher is installed in the movable transport space for the duration of the transport of the cargo and said fire extinguisher is removed from the movable transport space after the transport of the cargo.

19. The method of claim 16, characterized in that said fire extinguisher is installed in a movable personnel space or vehicle, such as a construction site module or a caravan.
